(19) United States
(12) Patent Application Publication
(10) Pub. No.: US 2012/0256994 A1
(43) Pub. Date: Oct. 11, 2012

(54) INKJET RECORDING DEVICE

(75) Inventor: Taiya Munenaka, Toyokawa-shi (JP)

(73) Assignee: Konica Minolta Business Technologies, Inc., Tokyo (JP)

(21) Appl. No.: 13/432,533

(22) Filed: Mar. 28, 2012

(30) Foreign Application Priority Data
Apr. 5, 2011 (JP) 2011-83227

(51) Int. Cl. B41J 2/01

(52) U.S. Cl. 347/103

(57) ABSTRACT

An inkjet recording device including an image support member in which a temperature-sensitive polymer layer is formed on the surface thereof; an ink discharge head which discharges, on the image support member, an ink obtained by dispersing a pigment into a water-based medium so as to form an image; a transfer roller which makes contact with the image support member; a second heating roller which heats the temperature-sensitive polymer layer; a water absorption roller that absorbs and removes water on the surface of the temperature-sensitive polymer layer. Thus, the bleeding of ink on a recording medium is reduced, and the efficiency of transfer of an image from the image support member to the recording medium is enhanced.

This application is based on Japanese Patent Application No. 2011-83227 filed on Apr. 5, 2011, the contents of which are hereby incorporated by reference.

### BACKGROUND OF THE INVENTION

1. Field of the Invention

The present invention relates to an inkjet recording device, and more particularly to an inkjet recording device that forms an ink image on an image support member and then transfers the ink image from the image support member to a recoding medium.

2. Description of the Related Art

An inkjet image forming device (inkjet recording device) that is disclosed in, for example, patent document 1 (Japanese Unexamined Patent Application Publication No. H7-276792) and that discharges, from an ink discharge head, ink droplets onto a recording medium to form an image has a simple structure and is easily decreased in size and weight as compared with an electrophotographic image forming device, is not required to have a heat fixing portion unlike the electrophotographic image forming device and consumes low power. Hence, in recent years, inkjet image forming devices have been widely used.

On the other hand, since the inkjet recording device uses an ink in which a pigment or a dye is dispersed as a coloring agent into a dispersion medium such as water, when an image is formed on plain paper without an ink absorption layer, the ink bleeds and thus the resolution is degraded.

Hence, various methods for reducing the bleeding of ink have so far been proposed. For example, the following methods are proposed: a method of spraying a flocculating agent on a recording medium before the formation of an ink image and thereby reducing the bleeding of the ink; a method of using a high viscosity pigment dispersion ink; a method of heating a solid ink within a head into a liquid ink and discharging its droplets onto a recording medium. Some methods are used in commercially available devices.

However, in the method of previously applying the flocculating agent on the recording medium, since it is necessary to dry the flocculating agent only for an extremely short period of time, about the same amount of power as used in the electrophotographic device may be required. Moreover, since the flocculating agent is also applied to a non-image formation region of the recording medium, an excessive amount of flocculating agent is inevitably used. In the method of using the high viscosity pigment dispersion ink, although the absorption of water by the recording medium is considered to be reduced as compared with a conventional method, since the amount of water absorbed by the recording medium is increased, the elasticity of the recording medium may be reduced if there is a large image formation part. In the method of using the solid ink, since the solid ink needs to be heated so that the ink is prevented from being solidified within the head, power consumption may be increased.

Furthermore, patent document 2 (Japanese Unexamined Patent Application Publication No. H5-200999) proposes a recording device that forms an image with a pigment dispersion ink on an intermediate transfer member, that absorbs and removes a solvent from the formed ink image and that then transfers the image from the intermediate transfer member to a recording medium.

However, in the technology proposed in patent document 2, although the bleeding of the ink image is supposed to be reduced, the adherence of the pigment to the intermediate transfer member is excessively increased, and thus the efficiency of transfer of the ink image to the recording medium may be reduced.

The present invention is made in view of the foregoing conventional problems; an object of the present invention is to provide an inkjet recording device that reduces the bleeding of an ink image on a recording medium without any increase in power consumption and that enhances the efficiency of transfer of an image from an image support member to the recording medium.

### SUMMARY OF THE INVENTION

According to the present invention, there is provided an inkjet recording device including: a rotatable image support member in which a temperature-sensitive polymer layer that is reversibly changed from hydrophilic to hydrophobic by heating is formed on a surface of the image support member; an ink discharge unit which discharges, on the image support member, an ink obtained by dispersing a pigment into a water-based medium so as to form an image; a transfer unit which makes contact with the image support member so as to transfer the image formed on the image support member to a recording medium; and a first heating unit which heats the temperature-sensitive polymer layer, in which, when the image is formed with the ink discharge unit, the temperature-sensitive polymer layer is changed to be hydrophilic so as to absorb water within the ink whereas, when the image formed on the image support member is transferred to the recording medium, the temperature-sensitive polymer layer is changed from hydrophilic to hydrophobic by heating with the first heating unit such that water is made to bleed from the temperature-sensitive polymer layer and that adherence of the pigment to the temperature-sensitive polymer layer is reduced.

A water addition unit which adds water to the temperature-sensitive polymer layer may be further provided on the upstream side of the transfer unit in the rotational direction of the image support member so that, when the image formed on the temperature-sensitive polymer layer is transferred, the amount of water bleeding from the temperature-sensitive polymer layer is adjusted to increase the efficiency of transfer of the image.

The first heating unit may be provided opposite the transfer unit such that the image support member is sandwiched between the first heating unit and the transfer unit. The first heating unit may also be provided in such a position as to heat the temperature-sensitive polymer layer through the transfer unit.

A second heating unit that heats the temperature-sensitive polymer layer and a water removal unit that removes the water bleeding from the temperature-sensitive polymer layer are preferably provided in this order on the downstream side of the transfer unit in the rotational direction of the image support member.

Preferably, the phase transition temperature of the temperature-sensitive polymer layer that is reversibly changed from hydrophilic to hydrophobic ranges from 5° C. to 45° C.

### BRIEF DESCRIPTION OF THE DRAWINGS

FIG. 1 A schematic diagram showing an example of an inkjet recording device according to the present invention; and

FIG. 2 A schematic diagram showing another example of the inkjet recording device according to the present invention.

### DESCRIPTION OF PREFERRED EMBODIMENTS

An inkjet recording device according to the present invention will be described below with reference to accompanying drawings; the present invention is not limited to these embodiments.

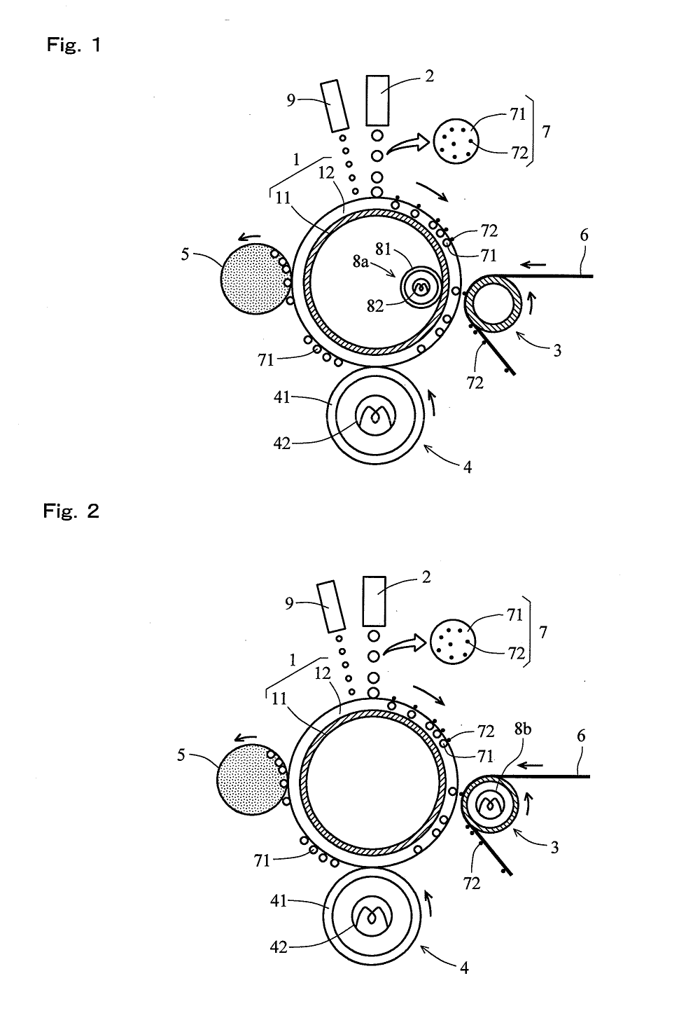

FIG. 1 a schematic diagram showing an example of the inkjet recording device according to the present invention. The inkjet recording device shown in this figure includes: an image support member 1 in which a temperature-sensitive polymer layer 12 is formed on the surface of a cylindrical base member 11; an ink discharge head 2 which forms an ink image on the temperature-sensitive polymer layer 12 based on an image signal; a transfer roller (transfer unit) 3 which makes contact with the image support member 1; a second heating roller (second heating unit) 4 which makes contact with the image support member 1 to heat the temperature-sensitive polymer layer 12 and which incorporates a rod-shaped halogen heater 42 around the center of a shaft of a rotatable cylindrical member 41; and a water absorption roller (water removal unit) 5 which absorbs and removes water on the surface of the temperature-sensitive polymer layer 12.

On the upstream side of the ink discharge head 2 in the rotational direction of the image support member 1, a water discharge head (water addition unit) 9 is provided; a first heating roller (first heating unit) 8a is provided in a position opposite the transfer roller 3 through the image support member 1 so as to make contact with the inner circumferential surface of the image support member 1. The first heating roller 8a includes a rotatable cylindrical member 81 and a rod-shaped halogen heater 82 around the center of a shaft of the cylindrical member 81.

The water discharge head 9 may be attached to the upstream side or the downstream side of the ink discharge head 2 as long as it is attached to the upstream side of the transfer roller 3 in the rotational direction of the image support member 1. However, when the water discharge head 9 is provided on the downstream side of the ink discharge head 2, an image is likely to “bleed” by the movement of an ink image caused by water discharged from the water discharge head 9. When a so-called solid image is formed, the density in the image is uneven, and thus variations occur in the amount of water absorbed by the temperature-sensitive polymer layer 12, with the result that variations in the efficiency of transfer occur locally. Hence, as shown in FIG. 1, the water discharge head 9 is preferably provided on the upstream side of the ink discharge head 2.

Although the inkjet recording device shown in this figure forms a single color image, the present invention can be naturally applied to a device that is provided with a plurality of ink discharge heads 2 and that can thereby discharge inks of a plurality of colors to form a color-ink image.

The temperature-sensitive polymer used in the present invention is a polymer that is hydrophilic at a temperature equal to or less than a phase transition temperature or is hydrophobic at a temperature equal to or more than the phase transition temperature. Examples thereof include single polymers and copolymers contain, as constituent units, N-isopropylacrylamide, N-methylacrylamide, N-acryloylpyrrolidine, N-vinylisobutylamide, vinyl ether and the like. The phase transition temperature of the temperature-sensitive polymer is preferably higher than the temperature within the device; in general, the phase transition temperature preferably falls within a range of 5° C. to 45° C.

In the image support member 1 used in the present invention, a layer formed of the temperature-sensitive polymer described above is formed on the surface of the cylindrical base member 11. As a method of forming the temperature-sensitive polymer layer 12 on the base member 11, for example, there is a method of forming the temperature-sensitive polymer in the shape of a sheet and then adhering it to the base member 11 with an adhesive such as a silane coupling agent or the like. Examples of the materials of the base member 11 include metal materials such as aluminum and stainless steel and plastic materials such as polyolefin, polyvinyl chloride and polyethylene terephthalate. The shape of the base member 11 is not limited to the cylindrical shape; the base member 11 may be, for example, an endless belt.

In the inkjet recording device configured as described above, an image is formed as follows. Water is first discharged from the water discharge head 9, and thus the water is distributed on the temperature-sensitive polymer layer 12. Here, the water is preferably distributed over only a portion where the image is to be formed. This is because, if the water is distributed even over a non-image formation portion, a larger amount of heating energy is required at the time of transfer, which will be described later, and water bleeding from the temperature-sensitive polymer layer 12 is absorbed by a recording medium 6, and thus the elasticity of the recording medium 6 is reduced. The temperature-sensitive polymer layer 12 is adjusted such that its temperature is kept lower than the phase transition temperature at least until immediately before the formation of the ink image in a transfer region by the transfer roller 3 since the addition of water by the water discharge head 9; in the meantime, the temperature-sensitive polymer layer 12 is kept hydrophilic.

Although, as a water addition unit, the water discharge head 9, a spray, a damp water immersion roller used in an offset printing machine or the like can be used, since the inkjet water discharge head 9 can distribute water over only the portion where the image is to be formed, the inkjet water discharge head 9 is preferably used. The amount of water discharged from the water discharge head 9 is preferably determined as appropriate such that the total amount of water discharged from the water discharge head 9 and water 71 within an ink 7 does not exceed the maximum water absorption amount. Specifically, the amount of water that bleeds from the temperature-sensitive polymer layer 12 through heating by the first heating roller 8a is preferably set such that a pigment 72 is prevented from being moved up at the time of transfer and that the adherence of the pigment 72 to the temperature-sensitive polymer layer 12 is reduced. When the temperature of heating by the first heating roller 8a, the amount of water within the ink 7, the amount of water absorbed by the temperature-sensitive polymer layer 12 and the like are adjusted, and thus it is possible to reduce, with only the water 71 within the ink 7, the adherence of the pigment 72 to the temperature-sensitive polymer layer 12 without the pigment 72 being moved up at the time of transfer, the water discharge head 9 may not be provided.

Then, the ink 7 is discharged from the ink discharge head 2 based on the image signal, and thus the ink image is formed on the temperature-sensitive polymer layer 12. In the ink discharge head 2 used in the present invention, a conventional known method such as an on-demand method or a continuous method can be used. Examples of the discharging method include: an electrical-to-mechanical conversion method such as a signal cavity type, a double cavity type, a vendor type, a piston type, a share mode type and a shared wall type; an electrical-to-heat conversion method such as a thermal inkjet type and a bubble jet (the registered trade mark); and an electro statical suction method such as a spark jet type. Furthermore, as the printing method, any method such as a serial head method and a line head method can be used.

Then, the image support member 1 is further rotated rightward in the figure by an unillustrated drive source, and the ink image is transported to a nip portion between the image support member 1 and the transfer roller 3. Until the ink image is rotated and transported to the nip portion, the water 71 within the ink 7 is absorbed by the temperature-sensitive polymer layer 12, and the pigment 72 is mainly left on the surface of the temperature-sensitive polymer layer 12. Then, in the nip portion, the temperature-sensitive polymer layer 12 is heated by the first heating roller 8a such that its temperature becomes equal to or more than the phase transition temperature, and thus the temperature-sensitive polymer layer 12 is changed from hydrophilic to hydrophobic, with the result that the water 71 is made to bleed from the temperature-sensitive polymer layer 12. In this way, the adherence of the pigment 72 to the surface of the temperature-sensitive polymer layer 12 is reduced, and thus the ink image is easily transferred to the recording medium 6 that has been transported to the nip portion by an unillustrated transport unit. Since, as described above, the amount of water absorbed by the temperature-sensitive polymer layer 12 is adjusted such that the pigment 72 is prevented from being moved up and that the adherence of the pigment 72 to the temperature-sensitive polymer layer 12 is reduced, the occurrence of the bleeding of the ink image on the recording medium 6, which is a conventional problem, is prevented. As the first heating unit, the first heating roller 8a or a conventional known heating unit of a contact method or a noncontact method can be used.

Here, in order for the efficiency of transfer to be further increased, in the transfer of the ink image from the image support member 1 to the recording medium 6, the ink image is preferably transferred to the recording medium 6 by setting the circumferential speed of the image support member 1 at the nip portion higher than the speed of transport of the recording medium 6 and utilizing the resulting shear stress. More preferably, the circumferential speed of the image support member 1 is set at 1.2 times or less the speed of transport of the recording medium 6.

After the transfer of the ink image to the recording medium 6, when the image support member 1 is further rotated, the temperature-sensitive polymer layer 12 is further heated by the second heating roller 4, and thus most of the water 71 absorbed by the temperature-sensitive polymer layer 12 bleeds on the surface. The heating temperature is preferably equal to or more than the phase transition temperature of the temperature-sensitive polymer layer 12; the phase transition temperature is set close to a normal temperature, and thus it is possible to reduce power consumption as compared with a conventional device. As the second heating unit for heating the temperature-sensitive polymer layer 12, the second heating roller 4 or a conventional known heating unit of a contact method or a noncontact method, such as a thermal head capable of selective heating, can be used. The second heating unit may be arranged either in the outer circumferential portion of or in the inner circumferential portion of the image support member 1.

Then, the water 71 bleeding from the temperature-sensitive polymer layer 12 is absorbed by a water absorption roller 5 that is rotated while being in contact with the image support member 1 and that is formed of porous material, and is removed from the surface of the image support member 1. The water 71 absorbed by the water absorption roller 5 may be collected by being sucked through a pump or the like from the center of a shaft of the water absorption roller 5 or the outer circumferential side. As the unit for removing the water 71 from the surface of the temperature-sensitive polymer layer 12, the water absorption roller 5 or a conventional known removal unit such as blade contact, heat drying or an air knife can be used.

Then, while the image support member 1 in which the water 71 on the surface has been removed by the water absorption roller 5 is rotated and moved to a position where the water is discharged by the water discharge head 9, the image support member 1 is cooled, and is then cooled such that its temperature becomes equal to or less than the phase transition temperature. Thus, the temperature-sensitive polymer layer 12 is changed from hydrophobic to hydrophilic, and the water distributed from the water discharge head 9 over the temperature-sensitive polymer layer 12 is absorbed by the temperature-sensitive polymer layer 12 as described above. In order for the image support member 1 to be reliably cooled to the phase transition temperature or less while the image support member 1 is being rotated from the water absorption roller 5 to the water discharge head 9, a cooling unit may be further provided between the water absorption roller 5 and the water discharge head 9. Examples of the cooling unit include air current cooling using a fan or the like, a heat pump and a Peltier element.

The ink 7 used in the present invention is an ink that is obtained by dispersing the pigment 72 into the water 71 serving as a medium, and may be mixed with a latex or a polymer as necessary. The pigment 72 may be a color material, a microcapsule containing a color material or the like.

According to the inkjet recording device described above, an ink image of high resolution can be formed on not only inkjet paper but also plain paper, art paper and the like that are the recording media 6 in which conventionally, an ink easily bleeds.

FIG. 2 is a schematic diagram showing another embodiment of the inkjet recording device according to the present invention. The inkjet recording device shown in this figure differs from the inkjet recording device of FIG. 1 in that the first heating unit heats the temperature-sensitive polymer layer 12 through the transfer roller 3. Specifically, a rod-shaped halogen heater 8b is provided, as the first heating unit, around the center of a shaft of the transfer roller 3, and the transfer unit and the first heating unit are integrally formed. In this way, the configuration of the device can be simplified. The halogen heater 8b may be provided close to the outside of the transfer roller 3 such that the halogen heater 8b heats the temperature-sensitive polymer layer 12 through the transfer roller 3.

Although, in the embodiments described above, the second heating roller 4 and the water absorption roller 5 remove the water absorbed by the temperature-sensitive polymer layer 12, only the second heating unit may remove the water absorbed by the temperature-sensitive polymer layer 12. For example, the second heating unit makes the water bleed from the temperature-sensitive polymer layer 12, and then vaporizes the water. In a specific example, a plurality of rod-shaped halogen heaters are used as the second heating unit, these halogen heaters are arranged apart opposite the surface of the image support member 1 and are spaced a predetermined distance apart in a circumferential direction, heat rays emitted from the halogen heaters are applied to the image support member 1 to heat it and the water is made to bleed from the temperature-sensitive polymer layer 12 and is vaporized. Alternatively, as the second heating unit, a heating roller of a contact method in which a porous layer is formed on its surface is used, and thus the temperature-sensitive polymer layer 12 may be heated such that its temperature becomes equal to or more than the phase transition temperature, and simultaneously the water bleeding from the temperature-sensitive polymer layer 12 may be absorbed.

### Example

### Preparation of the Temperature-Sensitive Polymer

Ion-exchange water was put into a container, and then deoxygenation was performed by nitrogen substitution. 0.1 wt % of N-isopropylacrylamide was added to the ion-exchange water, and thereafter nitrogen substitution was performed again, and the ion-exchange water was stirred. Then, 0.0075 m mol of methylene bisacrylamide serving as a cross-linker, 0.13 m mol of tetramethylethylenediamine serving as a polymerization accelerator and 0.0065 m mol of peroxydisulfuric acid serving as a polymerization initiator were added to 1 m mol of N-isopropylacrylamide. Then, the resulting solution was subjected to nitrogen substitution, then was stirred and was left stationary until the completion of gelification, with the result that the temperature-sensitive polymer was obtained. Thereafter, the obtained temperature-sensitive polymer was washed by pure water, and was used as a specimen.

(Transfer Test)

0 μL, 1 μL, 2 μL and 5 μL of water were dropped onto the portion of the layer formed of the prepared temperature-sensitive polymer where the image was to be formed. Moreover, the temperature-sensitive polymer layer was immersed in water that was equal to or more than the amount of water absorbed by the temperature-sensitive polymer layer and that was stored in a container, and thus the temperature-sensitive polymer layer having a water content ratio of 100% was prepared. Then, the ink discharge head of an inkjet recording device “PX-G920” made by Epson Corporation was used, and thus a specific letter of 12 points was formed with a water-based pigment ink on each of the prepared temperature-sensitive polymer layers.

Then, the temperature-sensitive polymer layer was brought in contact with the transfer roller, the temperature-sensitive polymer layer was heated to 60° C., plain paper “J paper” made by Konica Minolta Inc. was transported to the nip portion between the temperature-sensitive polymer layer and the transfer roller and the specific letter on the temperature-sensitive polymer layer was transferred to the plain paper. The circumferential speed of the temperature-sensitive polymer layer was set at 1.1 times the speed of transfer of the plain paper. The results are shown in Table 1.

On the other hand, as a comparative example, the temperature-sensitive polymer layer was not heated, the plain paper “J paper” made by Konica Minolta Inc. was transported to the nip portion between the temperature-sensitive polymer layer and the transfer roller and the specific letter on the temperature-sensitive polymer layer was transferred to the plain paper. The results are also shown in Table 1.

TABLE 1

| | Water droplet amount (μL) | | | | | |
|---|---|---|---|---|---|---|
| | 0 | 1 | 2 | 5 | ~ | Fully immersed |
| Heating (60° C.) | x | x | ∘ | ∘ | ~ | ∘*¹ |
| No heating | x | x | x | x | ~ | x |

*¹the elasticity of the plain paper was reduced
“∘”: the letter was legible
“x”: the letter was illegible

As understood from Table 1, in the reference example where the water was dropped and the temperature-sensitive polymer layer was heated, when the amount of water dropped was 2 μL or more, the letter transferred to the plain paper was legible. However, when excessive water was absorbed by the temperature-sensitive polymer layer (for example, full immersion), water was absorbed by the plain paper, and thus the elasticity of the plain paper was reduced. On the other hand, in the comparative example where the temperature-sensitive polymer layer was not heated, the letter transferred to the plain paper was illegible.

What is claimed is:

1. An inkjet recording device comprising:
a rotatable image support member in which a temperature-sensitive polymer layer that is reversibly changed from hydrophilic to hydrophobic by heating is formed on a surface of the image support member;
an ink discharge unit which discharges, on the image support member, an ink obtained by dispersing a pigment into a water-based medium so as to form an image;
a transfer unit which makes contact with the image support member so as to transfer the image formed on the image support member to a recording medium; and
a first heating unit which heats the temperature-sensitive polymer layer,
wherein, when the image is formed with the ink discharge unit, the temperature-sensitive polymer layer is changed to be hydrophilic so as to absorb water within the ink whereas, when the image formed on the image support member is transferred to the recording medium, the temperature-sensitive polymer layer is changed from hydrophilic to hydrophobic by heating with the first heating unit such that water is made to bleed from the temperature-sensitive polymer layer and that adherence of the pigment to the temperature-sensitive polymer layer is reduced.

2. The inkjet recording device of claim 1, further comprising:
a water addition unit which is provided on an upstream side of the transfer unit in a rotational direction of the image support member and which adds water to the temperature-sensitive polymer layer.

3. The inkjet recording device of claim 1,
wherein the first heating unit is provided opposite the transfer unit such that the image support member is sandwiched between the first heating unit and the transfer unit.

4. The inkjet recording device of claim 1,
wherein the first heating unit is provided in such a position as to heat the temperature-sensitive polymer layer through the transfer unit.

5. The inkjet recording device of claim 1,
wherein a second heating unit that heats the temperature-sensitive polymer layer and a water removal unit that removes the water bleeding from the temperature-sensitive polymer layer are provided in this order on a downstream side of the transfer unit in the rotational direction of the image support member.

6. The inkjet recording device of claim 1,
wherein a phase transition temperature of the temperature-sensitive polymer layer that is reversibly changed from hydrophilic to hydrophobic ranges from 5° C. to 45° C.
